(19) United States
(12) Patent Application Publication
(10) Pub. No.: US 2004/0001447 A1
(43) Pub. Date: Jan. 1, 2004

(54) Wireless communication airlink protocol

(76) Inventor: David C. Schafer, Bellevue, WA (US)

Correspondence Address: L. Lawton Rogers, III, Suite 700, 1667 K Street, N.W., Washington, DC, 20006, US

(21) Appl. No.: 10/183,364

(22) Filed: Jun. 28, 2002

(51) Int. Cl. H04J 3/00

(52) U.S. Cl. 370/280; 370/294; 370/337; 714/746

(57) ABSTRACT

The present invention relates to air-link protocols which optimally permit wireless communication in a point-to-multipoint communication system. The protocols include establishment of an adaptive time division duplex channel, dynamic allocation of bandwidth, provision of multiple modulation schemes within the TDD operation, and bandwidth allocation.

### RELATED APPLICATIONS

The present application is related to co-pending, commonly assigned U.S. patent application Ser. No. 09/434,707, entitled “SYSTEM AND METHOD FOR BROADBAND MILLIMETER WAVE DATA COMMUNCIATION”, which is a divisional of U.S. Pat. No. 6,016,313, entitled “SYSTEM AND METHOD FOR MILLIMETER WAVE DATA COMMUNICATION” currently undergoing two concurrent re-examinations as re-exam Ser. Nos. 90/005,726 and 90/005,974, co-pending, commonly assigned U.S. Pat. No. 6,404,755 entitled, “MULTI-LEVEL INFORMATION MAPPING SYSTEM AND METHOD”, the disclosures of each of which are incorporated herein by reference.

### BACKGROUND

The present invention relates to the provision of airlink protocols which facilitate wireless communication in a point-to-multipoint communication system. Wireless radio links have increasingly become important to provide data communication links for a variety of applications. For example, Internet Service Providers have begun to utilize wireless radio links within urban settings to avoid the installation expense of traditional wired connections or optical fiber. It may be advantageous to utilize wireless radio link systems to provide service to a plurality of users in a point-to-multipoint architecture. Point-to-multipoint systems typically consist of one or more hub units servicing a plurality of remote terminals (sometimes referred to as remote u its, nodes, or subscriber units). The remote terminals are typically associated with individual nodes on the system. For example, an individual remote terminal may be connected to a LAN to allow PC's on the LAN to bridge to other networks via the point-to-multipoint system. Each remote terminal communicates via a wireless channel with a particular hub unit. In a point-to-multipoint system, the hub unit may control communication between a portion of the plurality of remote terminals associated with a particular coverage area. The hub units schedule transmit and receive bursts to and from remote terminals. The hub units may distribute data packets received from a particular remote terminal to another remote terminal within the same coverage area via such frames to a traditional wired network backbone, or to another hub unit.

Wireless communication point-to-multipoint systems present several unique characteristics. For example, data traffic over a point-to-multipoint system may be bursty, rather than at a fixed or continuous data rate. Specifically, an Internet browser application executed on a remote terminal would typically require significant down link bandwidth while downloading HTML code from a website, but would require little or no bandwidth while a user reads the display associated with the HTML code. Additionally, the bandwidth requirements of many applications such as browsers may bc., asymmetric. Specifically, Internet browsers often download a large amount of data, but upload proportionally very little. Accordingly, point-to-multipoint systems may implement dynamic bandwidth allocation (DBA) techniques to maximize the data throughout associated with asymmetric, bursty traffic.

Additionally, various remote terminals may comprise different capabilities. For example, certain terminals may utilize a higher modulation level to provide higher communication rates. However, high modulation levels may require more sophisticated transceiver and radio elements that possess lower noise characteristics. Specifically, components associated with higher level modulation levels may involve greater complexity and hence greater expense. Thus, corporate enterprises may desire to utilize more sophisticated remote terminals, while individuals who do not require very high data rates may utilize less sophisticated terminal to lower hardware expenses.

In addition, remote terminals may experience very significant differentials in signal to noise ratios (SNR). First, remote terminals may be disposed at significantly variable distances. The power received from the hub by each terminal may vary greatly. Thus, the SNR will vary simply due to the distribution of remote terminals within a coverage area. Secondly, certain terminals in a urban setting may be subjected to side-band noise from other radio system utilizing adjacent spectrum, while other terminals may not experience such interference.

Therefore, it is an object of the present invention to provide an optimal signaling protocol to communicate data in a point-to-multipoint wireless system.

It is a further object of the present invention to provide a signaling protocol adapted to provide adaptive bandwidth allocation between forward and reverse channel directions.

It is a further object of the present invention to provide a signaling protocol adapted to provide wireless service to a number of mobile terminals utilizing varying modulation levels.

It is a further object of the present invention to provide signaling protocol to provide adaptation to varying system configurations such as variable guard times.

It is a further object of the present invention to provide a signaling protocol adapted to facilitate wireless connectivity between heterogeneous networks.

The present invention is directed to a system and method that provide an adaptive time division duplex (ATDD) channel scheme. To facilitate the ATDD scheme, the present invention provides a forward portion and reverse portion upon a communication channel. The present invention preferably divides the forward and reverse portions into discrete time slots. The time slots preferably comprise an integer number of time units. The beginning of the forward portion preferably comprises a control portion time slot. The time slot preferably comprises information regarding the length of data time slots. The control portion preferably comprises further control information, such as power commands and guard time adjustments. In addition, the control portion further comprises medium access control information specifying particular terminals permitted to transmit in discrete time slots of the reverse portion.

Moreover, the present invention utilizes a plurality of modulation levels within a single frame to provide service to heterogeneous remote terminals. Additionally, the use of a plurality of modulation levels permits the system to maximize bandwidth in view of the signal noise ration (SNR) experienced by particular terminals. As SNR increases, the modulation level may be increased without significantly affecting the bit error rate. Additionally, remote terminals disposed at further distances from the hub may utilize lower modulation levels to minimize the bit error rate. It shall be appreciated that the medium access control messages may cause remote terminals to utilize a particular modulation level. For example, a control message may indicate that a particular slot is associated with 16-QAM modulation. Later, a control message may indicate that a particular remote is permitted to transmit in the time slot on the reverse portion. Thus, the remote will use 16-QAM modulation when it transmits its data.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates an exemplary point-to-multipoint system architecture.

FIG. 2 illustrates an exemplary signal flow utilizing the inventive airlink protocol.

FIG. 3 illustrates an exemplary configuration of a ATDD frame structure.

FIG. 4 illustrates an exemplary forward portion comprising a plurality of time slots.

FIG. 5 illustrates an exemplary reverse portion comprising a plurality of time slots.

FIG. 6 illustrates an exemplary forward payload block.

FIG. 7 illustrates an exemplary reverse payload block.

FIG. 8 illustrates an exemplary forward control payload block.

### DETAILED DESCRIPTION

FIG. 1 illustrates exemplary point-to-multipoint system 100. System 100 comprises hub 101. Hub 101 preferably controls the communication. Hub 101 permits communication between the various terminal units 103, 104, 106. Also, hub 101 permits communication the hubs and other communications systems, such as the Internet, via backbone 108 and/or via air links there between. System 100 further comprises remote terminals 102, 104, and 106. The remote terminal units may be connected to any number of data processing equipment. For example, remote terminal 102 is shown connected to ATM switch 103 serving a plurality of processor systems. Similarly, remote terminal 106 is connected to LAN network 107. Remote terminal 104 is connected to individual processor system 105.

A hub in such a system may preferably comprise an antenna system, a transceiver system, and a processor system. The processor system may include a microprocessor, non-volatile memory, RAM, and various 1/0 ports. Preferably, the processor system manages communication over the coverage area containing the terminals units and the hub. For example, the processor system may implement an algorithm to schedule transmissions to/from hubs in accordance with various bandwidth allocation schemes. The programmable logic may be placed upon the non-volatile storage medium to be executed upon initialization of the hub.

In such a system or other point-to-multipoint architectures, an exemplary physical layer to support wireless connectively may preferably comprise the following characteristics:

| | |
|---|---|
| Frequency Band: | 20-43 GHz |
| Modulation Formats: | QPSK, 16-QAM, 32-QAM, 64-QAM |
| Baud Rates: | 5.120 to 40 Mbaud |
| Carrier Complex: | Modulation-slotted TDM (forward link) 1-9 |
| | Slots/Frame |
| | Frame TDMA (Reverse-Link) 1-32 Slots/Frame |
| Remote Terminals: | 1--128 |
| TDD Frame | |
| Duration: | b*.125 μsec (b is an integer) |
| Duplex Method: | Time Division Duplex |
| Payload FEC: | Reed-Solomon (120, 108) code word GF-256 |
| | (Forward Link) |
| | Reed-Solomon (60, 52) code word GF-256 |
| | (Reverse Link) |
| | Reed-Solomon (68, 48) code word GF-256 |
| | (Forward Link) |
| | Reed-Solomon (8, 4) code word GF-16 |
| | (Reverse Link) |

As previously noted, the initial spectrum allocation preferably utilizes a time division duplex scheme to facilitate communication between the remote units and the hub. The time duplex division (TDD) scheme successively utilizes a given channel to provide a forward link and a reverse link between the hubs and the remote terminals. In addition, the TDD approach may provide adaptive asymmetric duplexing. Specifically, more or less bandwidth may be allocated between the forward and reverse portions as necessary to efficiently satisfy outstanding bandwidth requirements according the various criteria, such as mean waiting times and through-put characteristics.

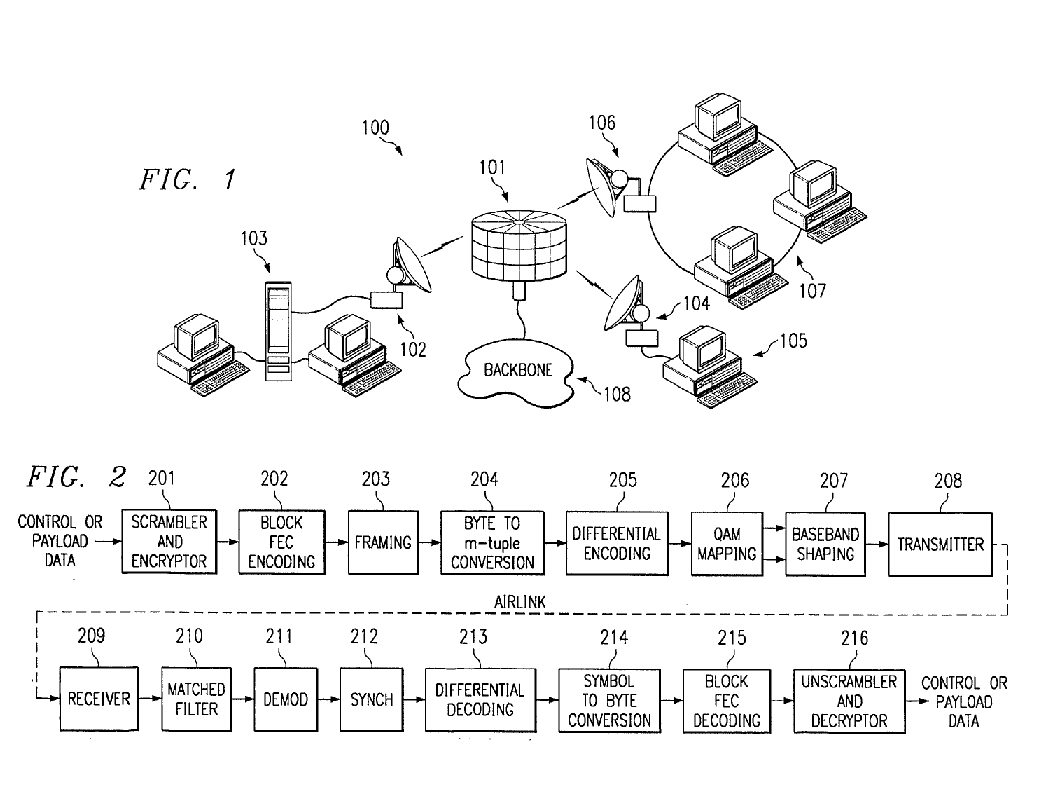

FIG. 2 illustrates an exemplary signal flow utilizing the present inventive airlink protocol. First, control and payload data is provided. In step 201, the data is scrambled and encrypted. In step 202, forward error correction (FEC) is performed. Unlike typical data communication systems such as TCP/IP systems, the present system preferably actively corrects errors produced by interference, distortion, noise, and/or the like. Other systems typically simply resend damaged packets. However, the application of FEC provides a more efficient use of the spectrum in noisy urban environments as compared to rebroadcast schemes. In step 203, data is framed. Since the point-to-multipoint system is designed to provide wireless communication capabilities to common data processing systems, the data is typically provided by byte format. Accordingly, the bytes are converted into m-tuple form in step 204. The exact m-tuple conversion depends upon the variable modulation level as will be discussed later in greater detail. In step 205, differential encoding is preferably applied to effectively encode the two most significant bits of each symbol. Thereafter, the symbols are preferably mapped into the appropriate QAM modulation space in step 206. In step 207, the baseband shaping preferably occurs via a square-root raised cosine filter. In step 208, the signal is transmitted over the predetermined channel. Thereafter, the reverse steps occur. The signal is received and placed in a matched filter in steps 209 and 210. In step 211, demodulation occurs. In step 212, synchronization occurs. In step 213, differential decoding preferably occurs. In step 214, symbol to byte conversion is performed. In step 215, block FEC decoding is performed and certain errors are corrected. In step 216, the data is unscrambled and decrypted.

FIG. 3 illustrates an exemplary configuration of an ATDD frame structure. As previously noted, the channel structure is preferably a TDD channel. The TDD frame structure preferably comprises a forward link portion 301, a first time guard 302, a reverse link portion 303, and a second guard time 304. In a preferred embodiment, the frame length is b*.125 μsec (where b is an integer). Also, the frame is preferably divided into an integer number of “time slices” known as Airlink Time Units (ATUs). In a preferred embodiment, the ATUs comprise 16 symbol durations. Moreover, the present invention preferably allows adaptation of the guard time depending upon individual system architectures, such as coverage or cell sizes. Configuration of the guard time may allow maximum utilization of allocated bandwidth.

In addition, the baud rate is preferably adjustable. Of course, the baud rate may be altered by varying the symbol rate. The adjustment of communication rates may also be achieved by modifying the modulation level. Preferably, the point-to-multipoint system utilizes variants of quadrature modulations schemes, including QPSK, 16-QAM, 32-QAM, and 64-QAM.

As illustrated in FIG. 6, the forward payload preferably communicates information via forward payload blocks containing payload data 601 and FEC information 602. The blocks may be produced via extraction of data from a data stream. The blocks are preferably constructed utilizing a forward error connection scheme, such as Reed-Solomon coding. In a preferred embodiment, the block comprises 108 bytes of payload bytes and 12 bytes of FEC information. Moreover, the blocks may preferably encapsulate two ATM cells for communication via the wireless link. As illustrated in FIG. 7, the reverse portion may communicate payload information in a similar structure, comprising payload data 701 and FEC information 702. However, it is preferred to utilize a 60 byte payload construction utilizing a 52 byte payload and 8 bytes of FEC information. In this approach, a single ATM cell may be encapsulated with the HEC information removed prior to encapsulation. Although the present invention preferably utilizes Reed-Solomon coding, any number of error correction schemes may be utilized including various polynomial techniques.

In addition, it is preferred to utilize greater error correction for control messages due to their impact upon system performance. An exemplary forward control payload block is shown in FIG. 8, comprising a message payload 801 and FEC information 802. In a preferred embodiment, the message payload comprises 48 bytes and the FEC information comprises 20 bytes. Thus, this configuration permits correction of a greater number of errors than the ordinary forward payload block.

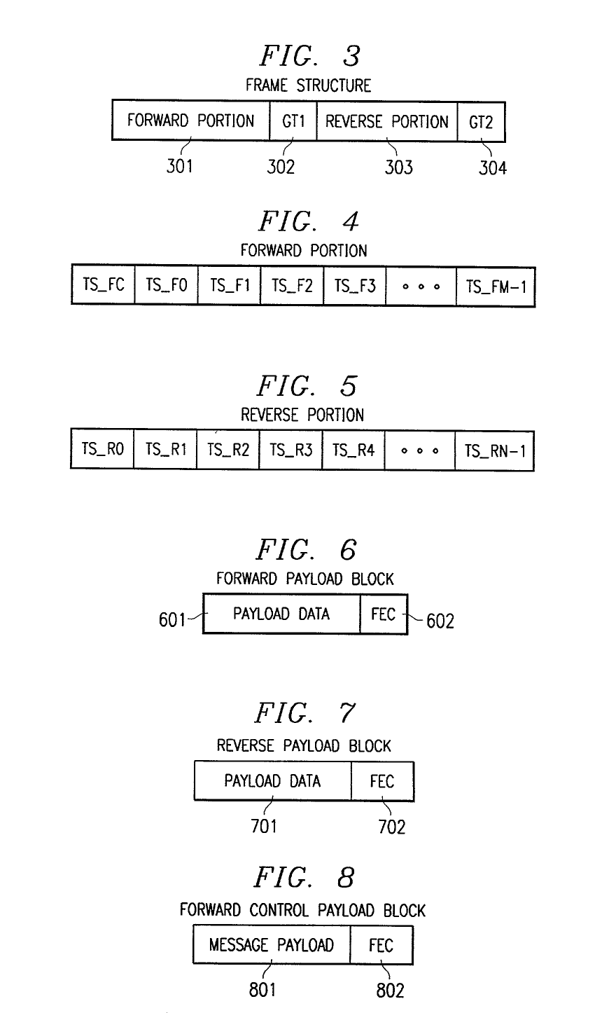

As shown in FIG. 4, the forward portion preferably comprises a plurality of time slots. First, the forward link preferably comprises control slots TS_Fc. In addition, the forward portion preferably comprises payload time slots TS_FO through TS-FM-1. In a preferred embodiment, the control time slot is included in each forward link portion. The control time slot may preferably include a ramp-up period, a preamble, an unique word, data portion, and a ramp-down portion. The present invention preferably communicates payload information utilizing varying modulation levels. However, it is preferred to solely utilize QPSK, or some other lowest level of modulation, modulation for preamble symbol sequences. By utilizing QPSK modulation for the preambles, it allows all remote terminals to determine the beginning of a particular slot, even though the data may be modulated utilizing a higher modulation level. By utilizing this modulation approach, the present invention adapts to remote terminals possessing differing capabilities, remote terminals disposed at varying distances, and varying signal to noise ratios.

The data portion preferably comprises an integer number of forward control payload blocks. The data portion preferably supports synchronization and control functionality. For example, the control time slot may provide medium access control messages. For example, a control time slot message may indicate that a remote terminal is allowed to transmit a message in the reverse direction at a specified time slot in a subsequent reverse link potion. Also, the control time slot messages may include power control information directed to particular terminals. The control time slot may also be utilized to automatically adjust synchronization of terminals, such as timing delay or adaptation of guard time.

The actual data communication from the hub to remote units preferably occurs via forward-link payload time slots. Each forward-link payload time slot preferably includes a ramp-up, preamble, unique word, payload, and ramp-down portions. The present invention preferably communicates payload information utilizing varying modulation levels. However, it is preferred to solely utilize QPSK modulation, or some other lowest level of modulation, for preamble symbol sequences. As previously noted, it is advantageous to allow dynamic bandwidth allocation. Accordingly, the payload portion may preferably comprise a variable integer number of forward payload blocks (although preferred embodiments of the present invention provide for payload blocks of varying duration or size). Accordingly, it is an advantage of the present invention to provide an easily adaptable air-link protocol to provide dynamic bandwidth allocation. The ease of adaptation is especially valuable for complex bandwidth allocation schemes. In certain bandwidth allocation schemes, overhead computational task may be quite extensive. However, the present air link approach may be utilized to reduce such computational difficulties by simplifying the adaptation process by providing integer-variable ATM cell communication. It shall further be appreciated that the present invention is advantageous in that it provides simplified connectivity between heterogeneous networks. By utilizing payload formats that encapsulates integer numbers of ATM cells, the present system requires much less processing to interface varying common data communication networks.

As previously noted, the present air link protocol permits various modulation levels to be utilized. A modulation index value may be used in control messages to reference various modulation levels. Control messages may specify that certain time slots are associated with a particular modulation index. For example, modulations index values of 0, 1, 2, 3 may be utilized by the system to refer to QPSK, 16-QAM, 32-QAM, and 64-QAM modulation levels, respectively. In a preferred embodiment, the forward portion comprises a plurality of forward payload time slots. For example, eight forward payload time slots may be utilized. Two time slots may be allocated for QPSK, 16-QAM, 32-QAM, and 64-QAM modulation levels. Thus, all remote terminals utilizing a particular modulation level would share the two time slots. If significant noise or fading is temporarily experienced, control messages may reconfigure the modulation levels to comprise four time slots of QPSK and four time slots of 16-QAM.

Moreover, the time slots may preferably be transmitted in order of the increasing modulation index value. The modulation level preferably increases monotonically, i.e. the modulation level of a payload time slot is always equal to or greater than the modulation level of the previous payload time slot. Thereafter, the modulation level starts at the lowest level when a new forward or reverse portion starts. By adjusting time slots in this fashion, the present invention adapts to remote terminals possessing differing capabilities, remote terminals disposed at varying distances, and varying signal to noise rations.

Bandwidth may be dynamically allocated between these time slots. For example, control messages may indicate start or end positions in terms of ATUs for various time slots. Alternatively, the time slots may be specified in terms of lengths in lieu of positions. Alternatively, and/or additionally, bandwidth may be allocated dynamically between the forward and reverse directions. A control message may specify the length of the forward portion. Similarly, a control message may specify the length of the reverse portion.

As illustrated in FIG. 5, the composition of the reverse link portion is somewhat similar to the forward system. The reverse portion may preferably comprise N time slots, from TS-RO through TS-RN-1. It shall be appreciated that N is not necessarily equal to M, where M was previously defined to constitute the number of forward time slots. Accordingly, the bandwidth of the channel may be allocated between the forward and reverse portions as necessary for outstanding bandwidth requests. There are preferably two distinct types of time slots, acquisition and communication. The acquisition portion is preferably utilized when a remote is first brought into active service or when reacquisition is necessary due to loss f link. The reverse link preferably comprises a plurality of communication time slots. The reverse link time slots preferably are implemented to provide a plurality of modulation levels as seen in the forward link. The reverse link time slots preferably order the modulation levels in an incremental manner. In addition, the remote terminals transmit in the respective time slots in a TDMA manner in accordance with the previously described medium access control messages. In a preferred embodiment, remote terminals only transmit within a slot after receiving permission to do so in a preceding forward control message. Each reverse payload time slot preferably comprises ramp-up, preamble, unique word, payload, ramp-down, and guard portions. The payload portion preferably comprises a variable integer number of reverse payload blocks (although preferred embodiments of the present invention provide for payload blocks of varying duration or size). As seen in the forward direction, the present invention preferably communicates reverse payload information utilizing varying modulation levels. However, it is preferred to solely utilize QPSK modulation, or some other lowest level modulation, for preamble symbol sequences.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of communicating over a forward portion of a time division duplex channel (TDD) to provide wireless connectivity between a hub and a plurality of remote terminals, comprising the steps of: assembling control and payload data; performing forward error correction on at least a portion of the assembled payload data to produce payload blocks; framing the payload blocks into a plurality of discrete time slots; performing byte to m-tuple conversion on the plurality of discrete time slots bytes to produce a series of binary symbols; modulating the series of binary symbols to produce a series of transmit symbols; baseband shaping the transmit symbols, and transmitting the transmit symbols.

2. The method of claim 1 further comprising the step of scrambling and encrypting the assembled data.

3. The method of claim 1 wherein the plurality of time slots comprises payload time slots and at least one control time slot.

4. The method of claim 1 wherein every frame transmitted over the forward portion comprises said at least one control time slot.

5. The method of claim 3 wherein said at least one control time slot is processed by each remote terminal.

6. The method of claim 5 wherein said at least one control time slot identifies payload time slot information.

7. The method of claim 6 wherein said at least one control time slot identifies a start location of a forward payload time slot.

8. The method of claim 6 wherein said at least one control time slot identifies a start location of a reverse payload time slot.

9. The method of claim 8 wherein said at least one control time slot identifying the start location of the reverse payload time slot is utilized to allocate bandwidth to a particular remote terminal.

10. The method of claim 3 wherein the time slots comprise ramp-up, preamble, unique word, payload, and ramp-down portions.

11. The method of claim 10 wherein the step of modulating includes modulating the payload portion of the time slots with varying modulation levels.

12. The method of claim 11 wherein the modulation levels monotonically increase with the transmission of time slots with a frame.

13. The method of claim 12 wherein the modulation method is a quadrature modulation method.

14. The method of claim 13 wherein the modulation levels include QPSK, 16-QAM, 32-QAM, and 64-QAM.

15. A signaling protocol for use in wireless point-to-multipoint communications, comprising:
a forward portion including a control time slot and a plurality of forward payload time slots, wherein each forward payload time slot is associated with a modulation level, and wherein the modulation levels of the forward payload time slots increase monotonically with forward time slot transmission; and
a reverse portion including a plurality of reverse payload time slots, wherein each reverse payload time slot is associated with a modulation level, and wherein the modulation levels of the reverse payload time slots increase monotonically with forward time slot transmission;
wherein at least two modulation levels are utilized in both of the forward portion and the reverse portion.

16. The signaling protocol of claim 15 wherein the modulation levels are QPSK, 16-QAM, 32-QAM, and 64-QAM.

17. The signaling protocol of claim 16 wherein the control time slot causes a remote terminal to utilize a particular modulation level.

18. The signaling protocol of claim 15 wherein the control time slot identifies a start location of a forward payload time slot.

19. The signaling protocol of claim 15 wherein the control time slot identifies a start location of a reverse payload time slot.

20. The signaling protocol of claim 19 wherein the control time slot allocates bandwidth to a particular terminal.

21. The signaling protocol of claim 16 wherein each time slot comprises a ramp-up, preamble, unique word, data, and ramp-down portions.

22. The signaling protocol of claim 21 wherein the preamble of each time slot is transmitted utilizing QPSK modulation.

23. An adaptive time division duplex (ATDD) frame for wireless communication in a point-to-multipoint system with the point-to-multipoint system including a plurality of remote terminals, comprising:
a forward portion including a control portion and a variable number of payload slots; and
a reverse portion including a variable number of payload slots;
wherein at least two modulation levels are utilized in the ATDD frame, wherein the control portion is transmitted utilizing a lowest modulation level of said at least two modulation levels, and wherein the control portion carries information with respect to the number of forward portion payload slots and the number of reverse portion payload slots.

24. The ATDD frame of claim 23 wherein the control portion carries information with respect to modulation levels to be utilized in a particular time slot.

25. The ATDD frame of claim 23 wherein said at least two modulation levels are selected from the group consisting of QPSK, 16-QAM, 32-QAM, and 64-QAM.

26. The ATDD frame of claim 25 wherein said at least two modulation levels increase monotonically within the forward portion.

27. The ATDD frame of claim 26 wherein said at least two modulation levels decrease monotonically within the reverse portion.

28. The ATDD frame of claim 23 wherein the length of at least one of the forward portion time slots and the number of reverse portion time slots are variable.

29. The ATDD frame of claim 23 wherein the forward portion time slots and the number of reverse portion time slots carry an integer number of ATM cells.
